(19) United States
(12) Patent Application Publication
(10) Pub. No.: US 2008/0013268 A1
(43) Pub. Date: Jan. 17, 2008

(54) Chassis design for computer systems

(76) Inventors: Hong W. Wong, Portland, OR (US); Wah Yiu Kwong, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/486,616

(22) Filed: Jul. 14, 2006

(51) Int. Cl. G06F 1/16

(52) U.S. Cl. 361/683

(57) ABSTRACT

An access panel is included in a base unit of a portable computer system. The access panel is positioned adjacent to a keyboard. The access panel may accommodate a touch pad and may include features to support left and right mouse buttons. A system board or electronic components inside the base unit may be accessed by opening the access panel and by detaching the keyboard. The access panel may be detached and replaced with a different version access panel. Each access panel version may include different functionalities.

### FIELD OF INVENTION

The present invention relates generally to the field of computer design, and more specifically, to techniques for improving accessibility to electronic components in computer systems.

### BACKGROUND

Mobile computer systems available in the market today come in many different form factors regardless whether they are manufactured by the same computer manufacturer or by different computer manufacturers. The mobile computer systems may be different in size and weight. Other factors that may cause these differences may be attributed to features and placement of electronic components in the mobile computer systems. In balancing the desire to increase the performance and to maintain the portability of mobile computer systems, designers continuously try to find ways to compact more sophisticated electronic components onto the system board of mobile computer systems while not compromising their portability and usability.

The system board of a mobile computer system may be enclosed in a thin housing. To provide access to the electronic components on the system board and to the system board itself, various panels may be used. For example, there may be a panel used to allow access to the memory slots, and there may be a panel used to access the battery. The panels may be attached using screws. Typically, accessibility is limited to only a few electronic components. When there is a problem with the system board, it is not uncommon for the user to send the entire computer system to the manufacturer or its authorized dealers to repair.

### BRIEF DESCRIPTION OF THE DRAWINGS

The present invention is illustrated by way of example and not limitation in the accompanying figures in which like references indicate similar elements and in which:

FIGS. 1A-1B are block diagrams illustrating an example of a computer system, in accordance with some embodiments.

FIGS. 2A-2D illustrate one example of a portable computer system having an access panel, in accordance with some embodiments.

FIGS. 3A-3D illustrate one example of incorporating an access panel into a cover panel in the base unit of a portable computer system, in accordance with some embodiments.

FIG. 4 illustrates another example of incorporating an access panel into a cover panel in the base unit of a portable computer system, in accordance with some embodiments.

FIGS. 5A-5F illustrate one example of assembling a base unit of a portable computer system designed with an access panel, in accordance with some embodiments.

FIGS. 6A-6B illustrate one example of using an access panel to change features associated with a base unit, in accordance with some embodiments.

FIGS. 7A-7B are block diagrams illustrating an example of a process that may be used, in accordance with some embodiments.

### DETAILED DESCRIPTION

For some embodiments, a portable computer system may include a display unit and a base unit. A top section of the base unit may include a keyboard and a cover panel. The cover panel may include an access panel that may be opened to allow accessibility to electronic components located within the base unit.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

### Computer System

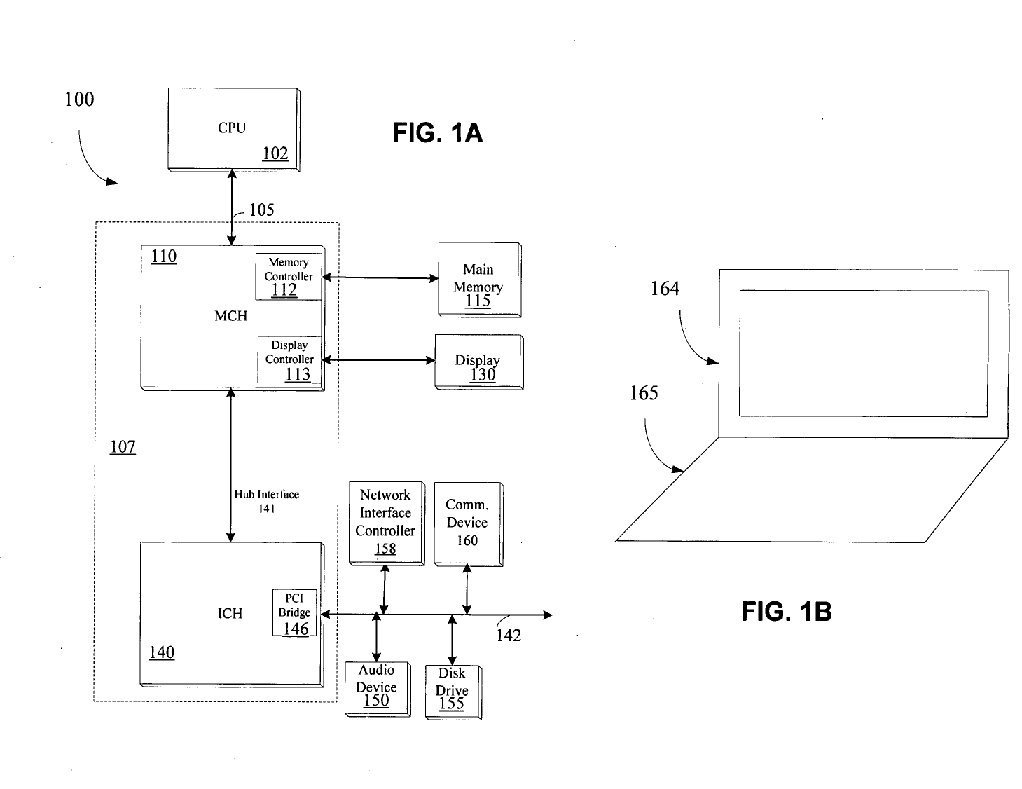

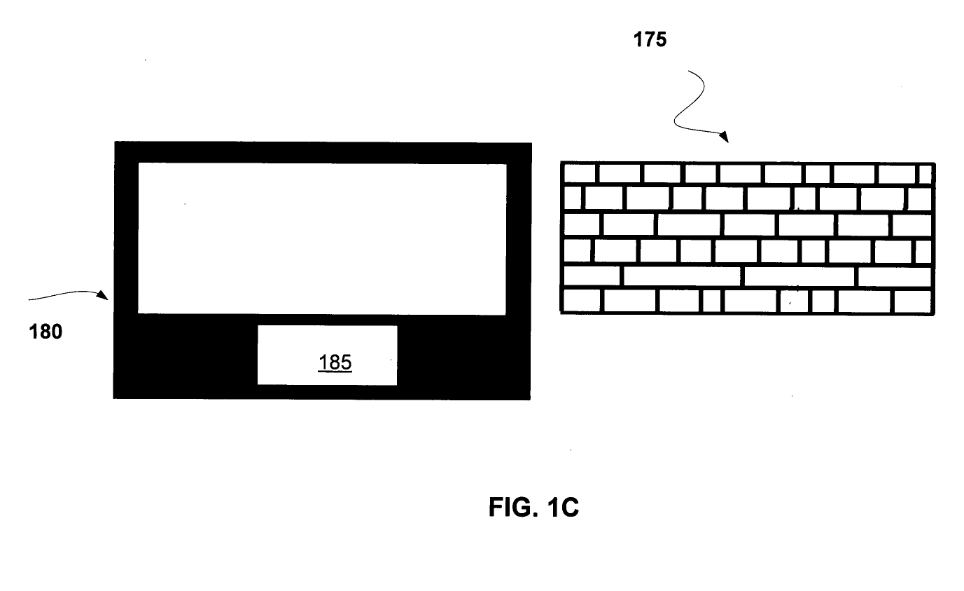

FIG. 1A is a block diagram illustrating an example of a computer system, in accordance with some embodiments. Computer system 100 may be a portable computer system. Computer system 100 may include a central processing unit (CPU) 102 and may receive its power from an electrical outlet, a battery (not shown), or any other power sources. The CPU 102 and chipset 107 may be coupled to bus 105. The chipset 107 may include a memory control hub (MCH) 110. The MCH 110 may include a memory controller 112 that is coupled to memory 115. The memory 115 may store data and sequences of instructions that are executed by the CPU 102 or any other processing devices included in the computer system 100. The MCH 110 may include a display controller 113. Display 130 may be coupled to the display controller 113. The chipset 107 may also include an input/output control hub (ICH) 140. The ICH 140 may be coupled with the MCH 110 via a hub interface 141. The ICH 140 may provide an interface to peripheral devices within the computer system 100. The ICH 140 may include PCI bridge 146 that provides an interface to PCI bus 142. The PCI bridge 146 may provide a data path between the CPU 102 and the peripheral devices. In this example, an audio device 150, a disk drive 155, communication device 160 and network interface controller 158 may be connected to the PCI bus 142. A keyboard (not shown) may be attached to the ICH 140 via an embedded controller (not shown) using the Low Pin Count bus (LPC) or the X-bus (both busses not shown).The disk drive 155 may include a storage media to store data and sequences of instructions that are executed by the CPU 102 or any other processing devices included in the computer system 100.

Computer manufacturers typically provide specifications and rely on Original Design Manufacturers (ODM) to assemble the computer systems in factories according to the specifications. The computer manufacturers may then apply their brands to these computer systems. It is possible to have one ODM assembling computer systems for different computer manufacturers using different specifications. There may be many different ODMs. The computer systems assembled by the ODMs may include different chassis or housing designs, different system board design, etc. The ODMs may need to pre-configure the same housing design with different system boards. One disadvantage of this approach is that the computer manufacturers may have to estimate product mixes since the configurations of the different system boards may only be assembled at the factories of the ODM.

For some embodiments, the computer systems may be portable computer systems each having a display unit and a base unit. One example is illustrated in FIG. 1B with display unit 164 and base unit 165. The display unit 164 may include the display 130, and the base unit 165 may include a keyboard (not shown), a system board, and other electronic components. When the computer systems are designed using thin and light weight form factor, it is often difficult to locate a particular electronic component inside the base unit without having to do extensive disassembly. FIG. 1C illustrates one example of disassembling a base unit of a portable computer system. To access a system board in a portable computer system, it may be necessary to first detach the display unit 164 from the base unit 165. Next, cover panel 180 may be removed from the base unit. Finally, keyboard 175 may be lifted from the base unit 165 to expose the system board (not shown). The last two steps may be interchanged. The cover panel 180 may include touch pad 185. The cover panel 180 may be commonly referred to as a “C” cover. It may be noted that the display unit 164 needs to be detached in order for the cover panel 180 to be removed. It may also be noted that multiple screws or fastening devices may need to be loosened to detach the display unit 164 and to remove the cover panel 180. Typically, when a portable computer system fails, it may be easier to send it back to the manufacturer for repair. Shipping cost and disassembly labor cost may contribute to the expensive warranty cost associated with portable computer. For example, the warranty cost is approximately one hundred and fifty U.S. dollars for a period of three years, even though a standard-featured portable computer system may cost only about 350 U.S. dollars per system.

### Cover Panel With Access Panel

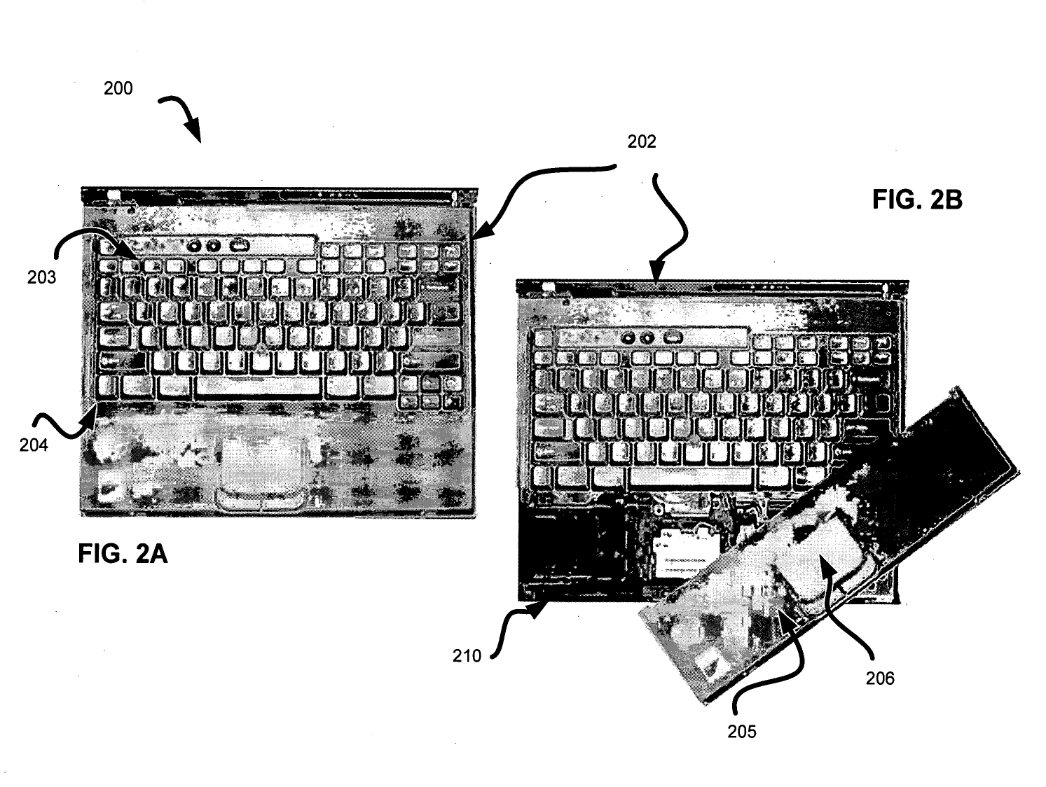

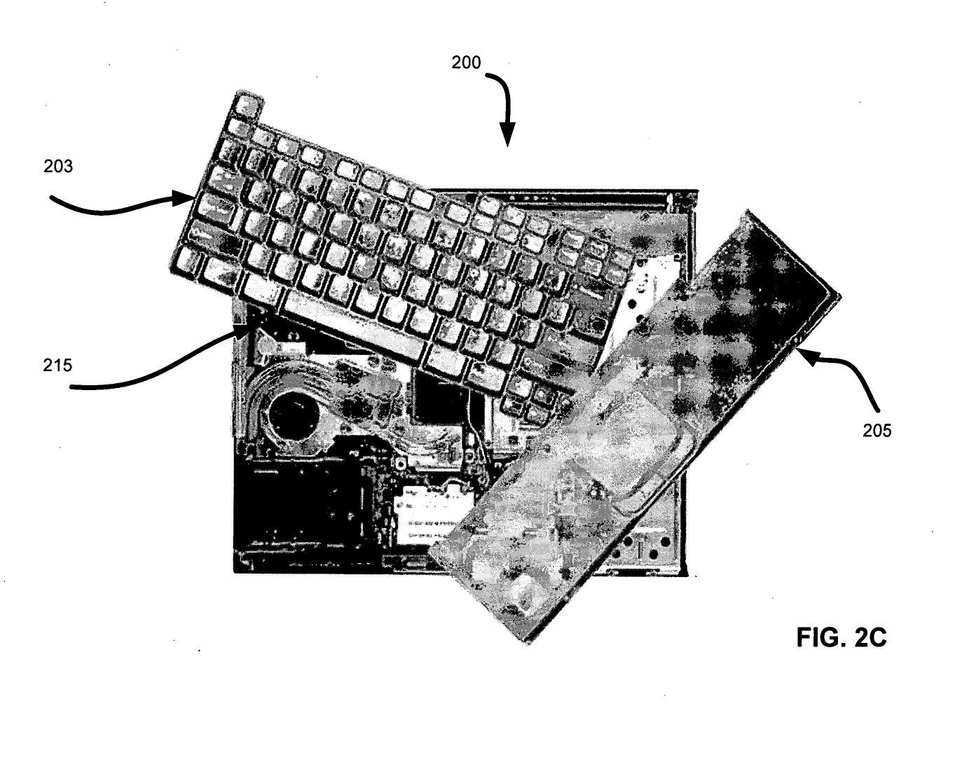

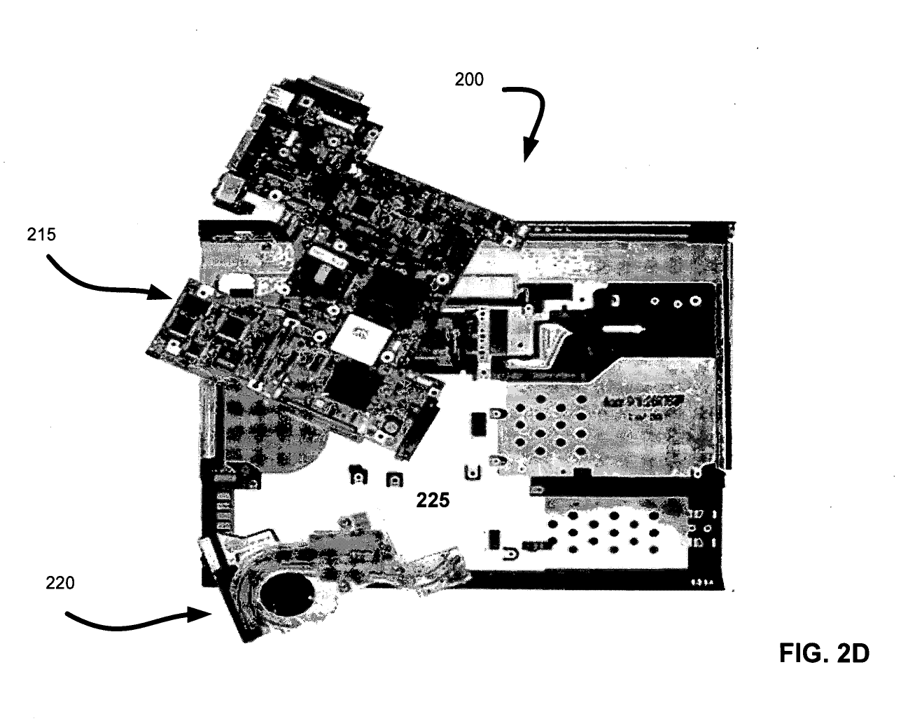

It would be advantageous to be able to quickly access the system board or an electronic component, and, if repair is necessary, to send just the failing system board or electronic component instead of the entire computer system to the manufacturer for repair. FIGS. 2A-2D illustrate one example of a portable computer system having an access panel, in accordance with some embodiments. Computer system 200 in this example may include base unit 202. The base unit 202 may include keyboard 203 and cover panel 204, as illustrated in FIG. 2A. The base unit 202 may also include a system board and other electronic components (not shown). The cover panel 204 may be used in similar applications as the cover panel 180 illustrated in FIG. 1C.

For some embodiments, a cover panel may include an access panel. The access panel may be used to quickly access electronic components in the base unit. The access panel may be positioned adjacent to the keyboard. FIG. 2B illustrates one example of an access panel, in accordance with some embodiments. In this example, the cover panel 204 may include access panel 205 which may be detached to expose electronic components 210 underneath. The access panel 205 may include touch pad 206. Alternatively, the access panel 205 may include an opening to accommodate a touch pad which may be coupled to the system board. It may be noted that after the access panel 205 is removed, a portion of the cover panel bordering three edges of the keyboard 203 may remain affixed to the base unit 202.

For some embodiments, when additional access is necessary, the keyboard may be removed. This is illustrated in FIG. 2C. Together with the opening of the access panel 205, the removal of the keyboard may make it easier to access system board 215 and other electronic components 220 in the base unit 202. This is illustrated in FIG. 2D.

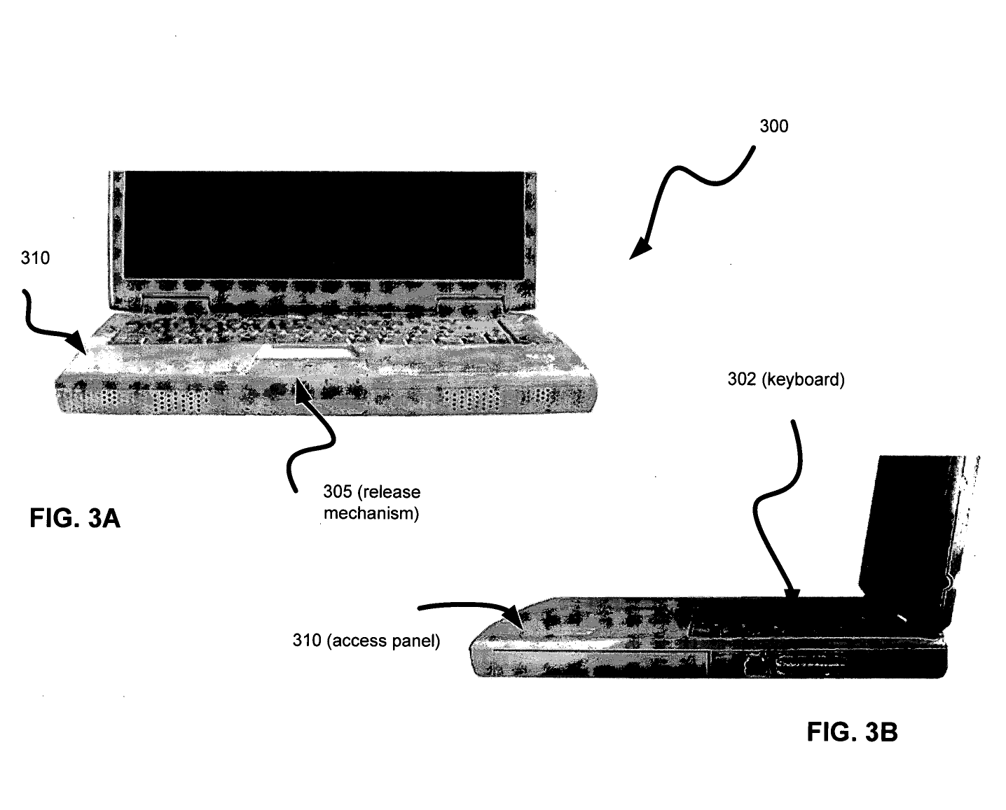

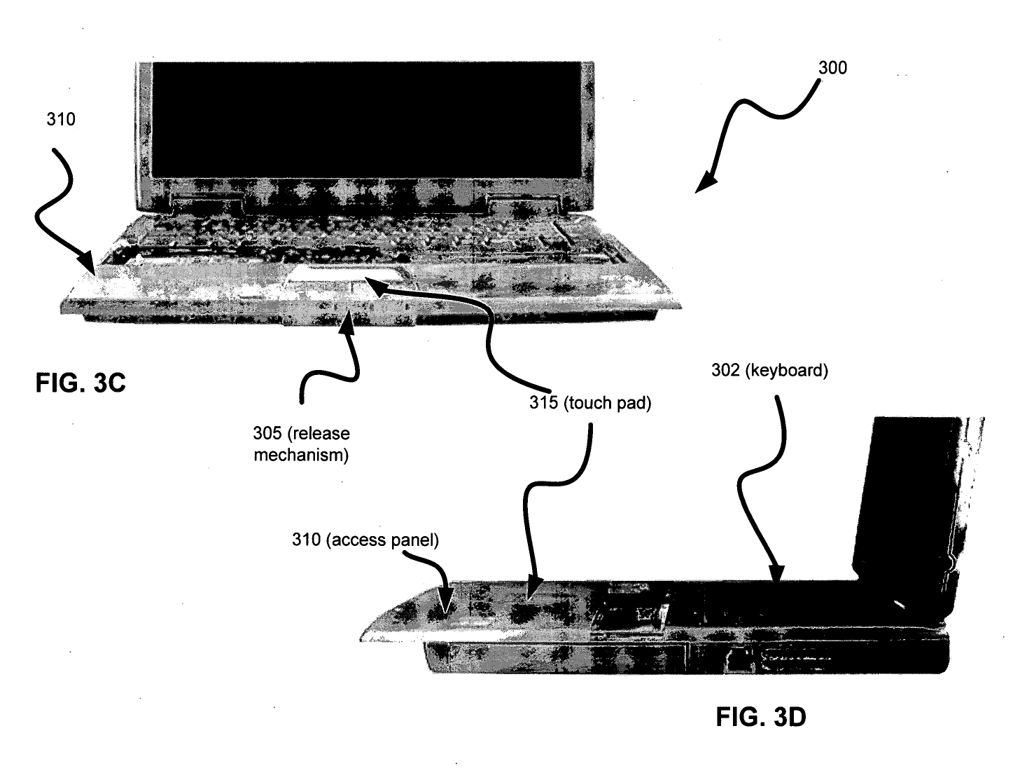

FIGS. 3A-3D illustrate one example of incorporating an access panel into a cover panel in the base unit of a portable computer system, in accordance with some embodiments. An access panel may be part of the cover panel. The access panel may be opened by sliding away from the keyboard along a track on the left edge and a track on the right edge. FIGS. 3A-3B illustrate a front view and a side view respectively of a slide-able access panel in its closed position, according to some embodiments. An access panel may include a touch pad. Alternatively, the access panel may include an area to accommodate a touch pad which may be coupled to a system board. In the current example, touch pad 315 is included in the access panel 310. For some embodiments, an access panel may need to be designed such that its movement is not restricted by any electronic components or cables associated with the touch pad. The access panel may include a release mechanism so that it can be detached from any electronic components or cablings associated with the touch pad. For example, prior to sliding the access panel 310 into an open position, release mechanism 305 may be activated. FIGS. 3C-3D illustrate a front view and a side view respectively of a slide-able access panel in its open position, according to some embodiments. The open position may be achieved by applying pressure to the release mechanism 305 and sliding the access panel 310 away from the keyboard 302. For some embodiments, when the access panel 310 is to slide toward the keyboard 302 in the closed position, the release mechanism is to enable the touchpad 315 to reconnect its associated electronic components. The access panel 310 may slide out and become completely separated from the computer system 300. Alternatively, the access panel 310 may be prevented from being completely separated from the computer system 300 when it is at a certain distance away from the keyboard 302.

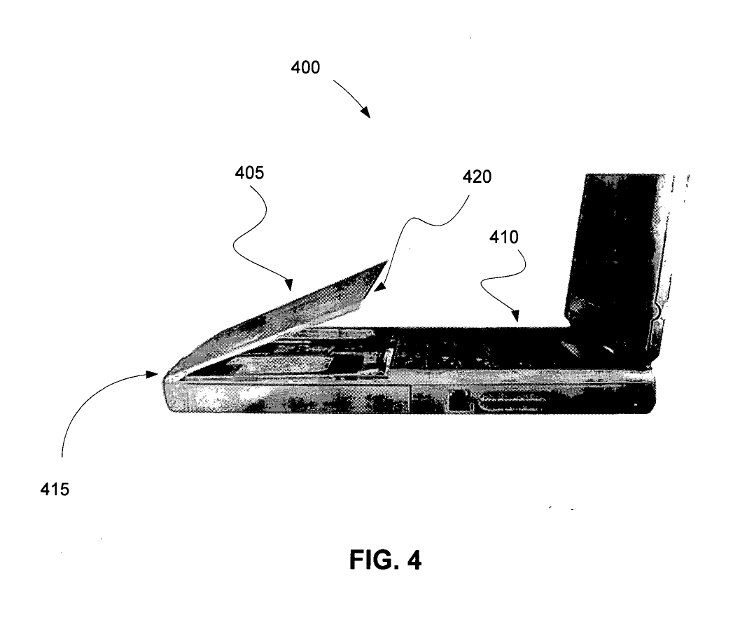

FIG. 4 illustrates another example of incorporating an access panel into a cover panel in the base unit of a portable computer system, in accordance with some embodiments. An access panel may be coupled to the base unit via one or more hinges or attachment devices that enable the access panel to be lifted from one edge while it remains connected to the base unit on another edge. As illustrated in FIG. 4, computer system 400 may include access panel 405. The access panel 405 may be opened by lifting an edge closest to keyboard 410 while remaining connected to the computer system 400 via attachment devices 415. It may be noted that the access panel 405 may also include a touch pad (not shown), and opening the access panel 405 may separate the touch pad from a touch pad cable (not shown) and its associated electronic components. It may be noted that although the length 420 of the access panel 405 may be approximately the length of the keyboard 410, it may be possible for the access panel 405 to be narrower, as long as it enables access to the electronic components inside the base unit.

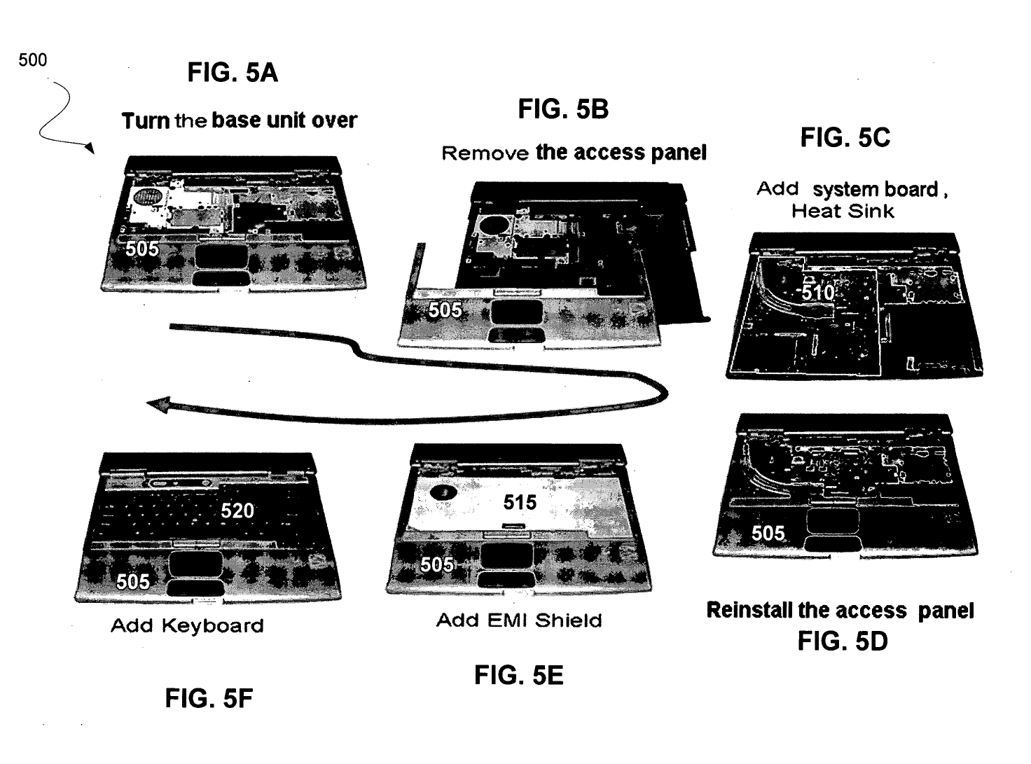

FIGS. 5A-5F illustrate one example of assembling a base unit of a portable computer system designed with an access panel, in accordance with some embodiments. It is assumed that the base unit 500 comes pre-assembled with an access panel but still requires a system board and a keyboard to be installed. To open access panel 505, screws or tightening devices may need to be loosened from the bottom of the base unit 500. The bottom of the base unit 500 is the side opposite the keyboard side. When the screws have been loosened, the base unit 500 may be turned over, as illustrated in FIG. 5A. The access panel 505 may then be removed to allow more access to the interior of the base unit 500, as illustrated in FIG. 5B. In the current example, removing the access panel 505 may include completely separating the access panel 505 from the base unit 500. Next, a system board 510 may be installed. In addition to the system board 510, other electronic components and thermal cooling devices (not shown) may be installed, as illustrated in FIG. 5C. Next, the access panel 505 may be reinstalled, as illustrated in FIG. 5D. It may be possible that in some embodiments, a keyboard may be installed before reinstalling the access panel 505. An electro magnetic interference (EMI) shield 515 may be installed to shield the system board 510, as illustrated in FIG. 5E. Finally, keyboard 520 may be installed on top of the EMI shield 515, as illustrated in FIG. 5F. Although not shown, other components may also be installed in between operations described in FIGS. 5A-5F.

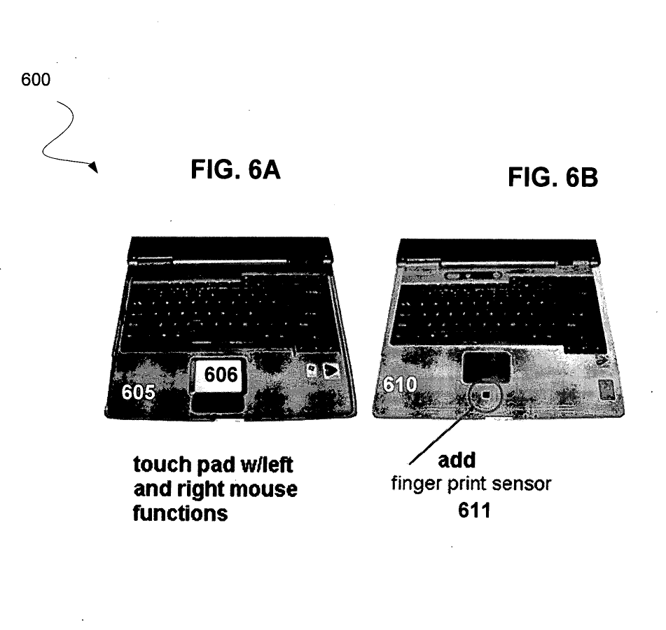

FIGS. 6A-6B illustrate one example of using an access panel to change features associated with a base unit, in accordance with some embodiments. One advantage of having an access panel is the ability to easily use different access panels to provide different configuration features. For some embodiments, a standard access panel may include a touch pad and mechanisms to enable functionalities similar to left and right mouse buttons. Access panel 605 with a touch pad 606 is illustrated in FIG. 6A. Different versions of access panels may be available. For example, when a finger print sensor function is desired, the access panel 605 may be easily removed and replaced with access panel 610 which includes the finger print sensor 611, as illustrated in FIG. 6B. Of course, the features that are available on an installed access panel need to be supported by the system board inside the base unit.

With the addition of an access panel in the cover panel of a base unit, the process of opening up the base unit to access the system board and any other electronic components may become easier. Upgrading or repairing a portable computer system may be performed by computer system retailers or computer system integrators. This may reduce the needs to send the computer systems to the manufacturer, and as such, may reduce the support cost as well as the time that a user has to wait for the computer system to be repaired.

### Process

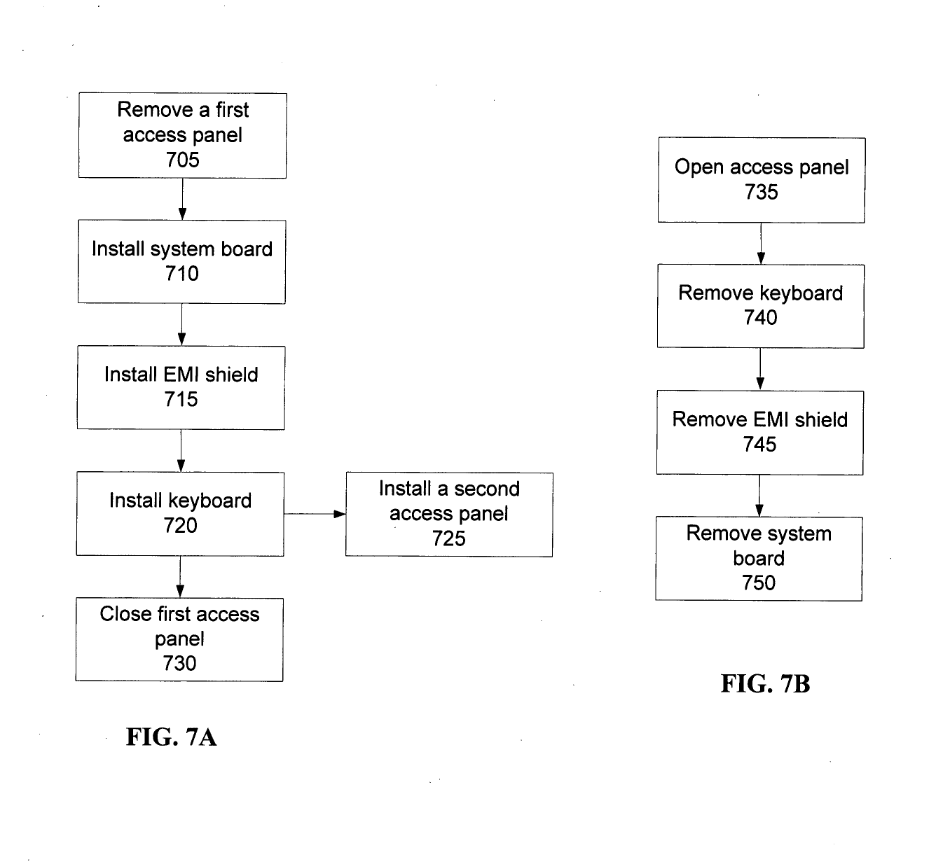

FIGS. 7A-7B are block diagrams illustrating an example of a process that may be used, in accordance with some embodiments. FIG. 7A describes an example process of assembling a base unit that is preconfigured with a first access panel. The base unit may basically be an empty housing with no keyboard or system board. The first access panel may be an access panel with standard features such as, for example, a touch pad and left and right mouse click functions. At block 705, the access panel is opened. At block 710, a system board is installed. At block 715, an EMI shield is installed. At block 720, a keyboard is installed. It is possible that the pre-configured access panel may not include certain specific functionalities (e.g., finger print sensor). In that situation, an access panel with the desired functionalities may be used and installed, as shown in block 725. It may be noted that the system board installed according to block 710 may include electronic components to support the fingerprint sensor functions. Alternatively, when the pre-configured access panel is sufficient, the process flows from block 720 to block 730 where the first access panel is installed.

FIG. 7B describes an example process of disassembling a base unit that includes an access panel. At block 735, the access panel is opened. At block 740, the keyboard is removed. At block 745, the EMI shield is removed. At block 750, the keyboard is removed. It may be noted that in some embodiments, the operations of removing the keyboard and removing the access panel may be interchangeable, depending on whether removing the access panel or removing the keyboard may be in the way of the other. When this process is used to replace a system board, a new system board may be installed starting at block 710 in FIG. 7A.

Although some embodiments of the present invention have been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A portable computer system, comprising:
a system board housed in a base unit, wherein the base unit includes a keyboard; and
an access panel positioned adjacent to the keyboard, wherein the access panel includes a touch pad, and wherein the access panel is to be opened to access the system board.

2. The system of claim 1, wherein the keyboard is to be detached from the base unit to access the system board.

3. The system of claim 2, wherein the access panel is coupled to the base unit.

4. The system of claim 3, wherein the access panel is opened by sliding away from the keyboard and closed by sliding toward the keyboard.

5. The system of claim 3, wherein the access panel is opened by rotating along one edge away from the keyboard and closed by rotating along the edge toward the keyboard.

6. The system of claim 3, wherein the access panel is detachable from the base unit.

7. The system of claim 6, wherein a first access panel is replaced by detaching it from the base unit and attaching a second access panel to the base unit.

8. The system of claim 7, wherein the second access panel includes features not included in the first access panel.

9. An apparatus, comprising: a housing to accommodate a system board associated with a computer system, the housing including a bottom surface and a top surface, the top surface including a detachable access panel and an opening to accommodate a keyboard, wherein the detachable access panel is to be opened to enable installation of the system board into the housing.

10. The apparatus of claim 9, wherein the access window is opened by sliding motion.

11. The apparatus of claim 9, wherein the access window is opened by rotating motion.

12. The apparatus of claim 9, wherein the keyboard is placed into the opening after the system board is installed into the housing.

13. The apparatus of claim 12, wherein the access panel is to be closed along with the keyboard being in the housing.

14. The apparatus of claim 13, wherein when the system board is capable of accommodating functionalities not supported by a current access panel, the current access panel is replaced by an access panel that supports the functionalities.

15. A method, comprising:
providing a portable computer system base unit to accommodate a system board and a keyboard, wherein the base unit is to include an access panel positioned adjacent to the keyboard, and wherein installation or removal of electronic components in the base unit is performed when the access panel is opened and the keyboard is detached.

16. The method of claim 15, wherein installation or removal of electronic components in the base unit include installation or removal of the system board.

17. The method of claim 15, wherein the access panel is opened by causing it to slide away from the keyboard.

18. The method of claim 15, wherein the access panel is opened by causing it to rotate away from the keyboard along an edge.

19. The method of claim 15, wherein the access panel includes a touch pad and features to support left and right button mouse functions.

20. The method of claim 19, further comprising: detaching the access panel and replacing it with another access panel that includes features to support additional functions.
